(19) United States
(12) Patent Application Publication
(10) Pub. No.: US 2012/0309530 A1
(43) Pub. Date: Dec. 6, 2012

(54) REIN-CONTROLLING GESTURES

(75) Inventors: Tom Lansdale, Guildford (GB); Charles Griffiths, Guildford (GB); Guy Simmons, Hampshire (GB)

(73) Assignee: MICROSOFT CORPORATION, Redmond, WA (US)

(21) Appl. No.: 13/149,730

(22) Filed: May 31, 2011

(51) Int. Cl. A63F 13/06

(52) U.S. Cl. 463/36

(57) ABSTRACT

Gestures of a computer user are observed with a depth camera. A gesture of the computer user is identified and an in-game parameter within an interactive interface is adjusted based on the gesture. According to one aspect of the disclosure, this type of gesturing is used for controlling the reins of a virtual animal within a animal driving or riding game interface.

### BACKGROUND

While camera technology allows images of humans to be recorded, computers have traditionally not been able to use such images to accurately assess how a human is moving within the images. Recently, technology has advanced such that some aspects of a human's movements may be interpreted with the assistance of a plurality of special cameras and one or more tracking tags. For example, an actor may be carefully adorned with several tracking tags (e.g., retro-reflectors) that can be tracked with several cameras from several different positions. Triangulation can then be used to calculate the three-dimensional position of each reflector. Because the tags are carefully positioned on the actor, and the relative position of each tag to a corresponding part of the actor's body is known, the triangulation of the tag position can be used to infer the position of the actor's body. However, this technique requires special reflective tags, or other markers, to be used.

In science fiction movies, computers have been portrayed as intelligent enough to actually view human beings and interpret the motions and gestures of the human beings without the assistance of reflective tags or other markers. However, such scenes are created using special effects in which an actor carefully plays along with a predetermined movement script that makes it seem as if the actor is controlling the computer's scripted actions. The actor is not actually controlling the computer, but rather attempting to create the illusion of control.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Gestures of a computer user are observed with a depth camera. A gesture of the computer user is identified and an in-game parameter within an interactive interface is adjusted based on the gesture. According to one aspect of the disclosure, this type of gesturing is used for controlling the reins of a virtual animal within an animal driving or riding game interface.

### BRIEF DESCRIPTION OF THE DRAWINGS

FIG. 1 shows a game player playing an animal driving game in accordance with an embodiment of the present disclosure.

FIG. 2 shows an example skeletal modeling pipeline in accordance with an embodiment of the present disclosure.

FIG. 3 shows an example method in accordance with an embodiment of the present disclosure.

FIGS. 4-7 show examples of skeletons performing rein-controlling gestures in accordance with various embodiments of the present disclosure.

FIG. 8 shows a skeleton performing an example item-collecting gesture in accordance with an embodiment of the present disclosure.

FIG. 9 schematically shows a computing system in accordance with an embodiment of the present disclosure.

### DETAILED DESCRIPTION

A depth-image analysis system, such as a 3D-vision computing system, may include a depth camera capable of observing one or more game players or other computer users. As the depth camera captures images of a game player or other computer user within an observed scene, those images may be interpreted and modeled with one or more virtual skeletons. Various aspects of the modeled skeletons may serve as input commands to an interactive user interface. For example, a cart driving game may interpret the physical movements of the game player as commands to control an in-game player character that is reining a horse to drive a cart.

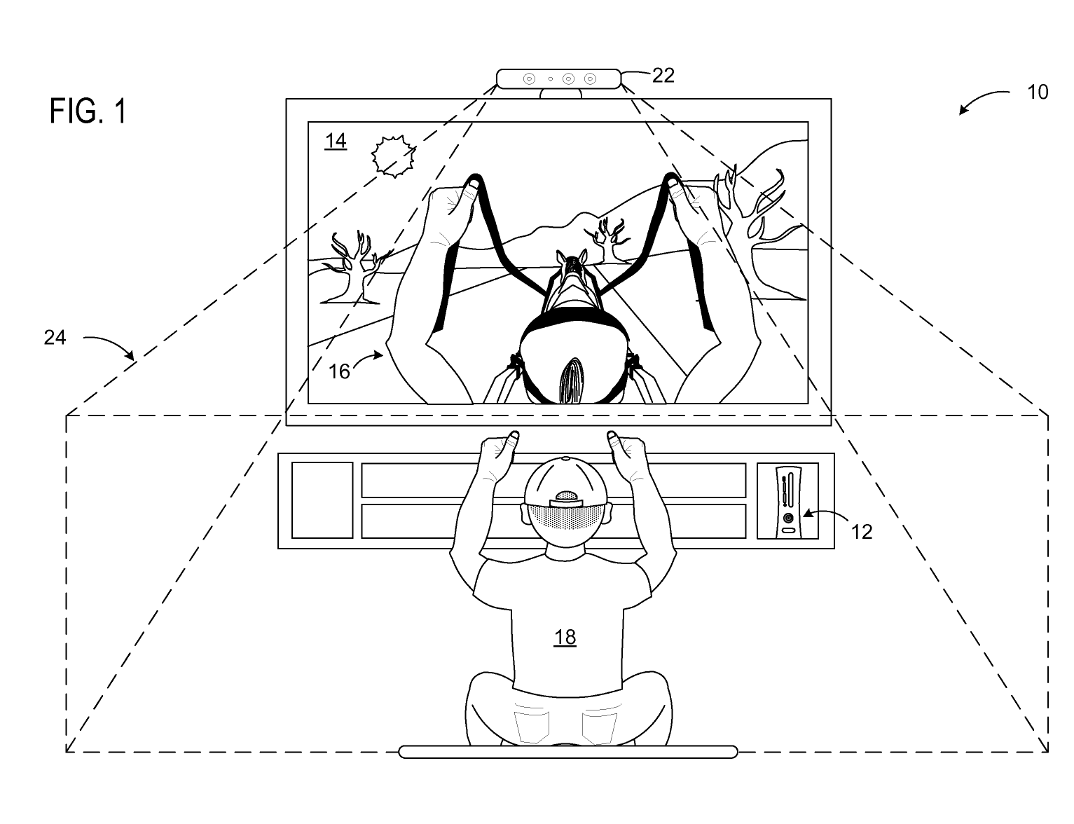

FIG. 1 shows a non-limiting example of an entertainment system 10. In particular, FIG. 1 shows a gaming system 12 that may be used to play a variety of different games, play one or more different media types, and/or control or manipulate non-game applications and/or operating systems. FIG. 1 also shows a display device 14 such as a television or a computer monitor, which may be used to present game visuals to game players. As one example, display device 14 may be used to visually present hands of an in-game player character 16 that game player 18 controls with his movements. Furthermore, display device 14 may be used to visually present a virtual animal 19 and reins 21 extending between the hands of the in-game player character 16 and the virtual animal 19. Such a visual presentation helps establish the impression that the real world movements of game player 18 control the movements of the in-game player character 16, which in turn controls the virtual animal 19 via the reins 21.

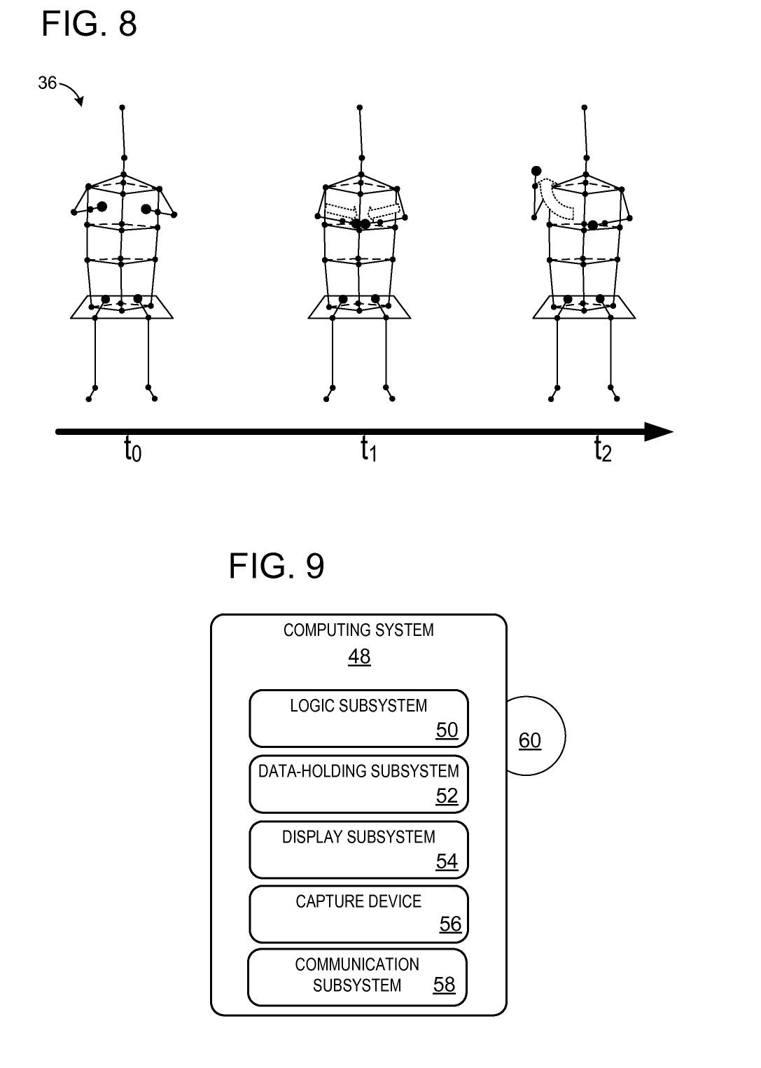

The entertainment system 10 may include a capture device, such as a depth camera 22 that visually monitors or tracks game player 18 within an observed scene 24. Depth camera 22 is discussed in greater detail with respect to FIG. 9.

Game player 18 is tracked by depth camera 22 so that the movements of game player 18 may be interpreted by gaming system 12 as controls that can be used to affect the game being executed by gaming system 12. In other words, game player 18 may use his or her physical movements to control the game without a conventional hand-held game controller or other hand-held position trackers. For example, in FIG. 1 game player 18 is performing horse-driving gesture to encourage a horse to gallop faster. The movements of game player 18 may be interpreted as virtually any type of game control. Some movements of game player 18 may be interpreted as player character controls to control the actions of the game player's in-game player character. Some movements of game player 18 may be interpreted as controls that serve purposes other than controlling an in-game player character. As a non-limiting example, movements of game player 18 may be interpreted as game management controls, such as controls for selecting a character, pausing the game, or saving game progress.

Depth camera 22 may also be used to interpret target movements as operating system and/or application controls that are outside the realm of gaming. Virtually any controllable aspect of an operating system and/or application may be controlled by movements of game player 18. The illustrated scenario in FIG. 1 is provided as an example, but is not meant to be limiting in any way. To the contrary, the illustrated scenario is intended to demonstrate a general concept, which may be applied to a variety of different applications without departing from the scope of this disclosure. As such, it should be understood that while the human controlling the computer is referred to as a game player, the present disclosure applies to non-game applications, and while the system is referred to as an entertainment system, the system may be used for non-entertainment purposes.

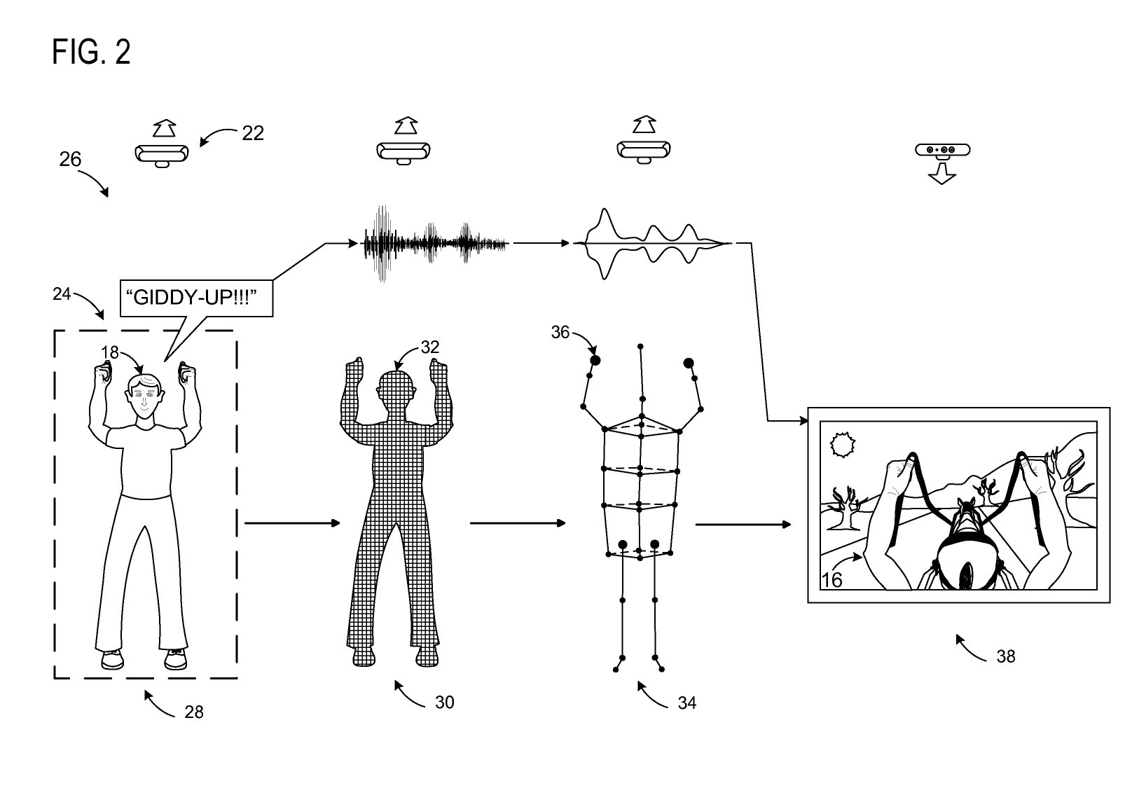

FIG. 2 shows a simplified processing pipeline 26 in which game player 18 in an observed scene 24 is modeled as a virtual skeleton 36 that can serve as a control input for controlling various aspects of a game, application, and/or operating system. FIG. 2 shows four stages of the processing pipeline 26: image collection 28, depth mapping 30, skeletal modeling 34, and game output 38. For simplicity of understanding, each stage of the processing pipeline shows the orientation of depth camera 22 relative to game player 18. It will be appreciated that a processing pipeline may include additional steps and/or alternative steps than those depicted in FIG. 2 without departing from the scope of this disclosure.

During image collection 28, game player 18 and the rest of observed scene 24 may be imaged by a depth camera 22. In particular, the depth camera is used to observe gestures of the game player. During image collection 28, the depth camera may determine, for each pixel, the depth of a surface in the observed scene relative to the depth camera. Virtually any depth finding technology may be used without departing from the scope of this disclosure. Example depth finding technologies are discussed in more detail with reference to FIG. 9.

During depth mapping 30, the depth information determined for each pixel may be used to generate a depth map 32. Such a depth map may take the form of virtually any suitable data structure, including but not limited to a matrix that includes a depth value for each pixel of the observed scene. In FIG. 2, depth map 32 is schematically illustrated as a pixelated grid of the silhouette of game player 18. This illustration is for simplicity of understanding, not technical accuracy. It is to be understood that a depth map generally includes depth information for all pixels, not just pixels that image the game player 18. Depth mapping may be performed by the depth camera or the gaming system, or the depth camera and the gaming system may cooperate to perform the depth mapping.

During skeletal modeling 34, one or more depth images (e.g., depth map 32) of a world space scene including a computer user (e.g., game player 18) are obtained from the depth camera. Virtual skeleton 36 may be derived from depth map 32 providing a machine readable representation of game player 18. In other words, virtual skeleton 36 is derived from depth map 32 to model game player 18. The virtual skeleton 36 may be derived from the depth map in any suitable manner. In some embodiments, one or more skeletal fitting algorithms may be applied to the depth map. For example, a prior trained collection of models may be used to label each pixel from the depth map as belonging to a particular body part, and virtual skeleton 36 may be fit to the labeled body parts. The present disclosure is compatible with virtually any skeletal modeling techniques.

The virtual skeleton provides a machine readable representation of game player 18 as observed by depth camera 22. The virtual skeleton 36 may include a plurality of joints, each joint corresponding to a portion of the game player. Virtual skeletons in accordance with the present disclosure may include virtually any number of joints, each of which can be associated with virtually any number of parameters (e.g., three dimensional joint position, joint rotation, body posture of corresponding body part (e.g., hand open, hand closed, etc.) etc.). It is to be understood that a virtual skeleton may take the form of a data structure including one or more parameters for each of a plurality of skeletal joints (e.g., a joint matrix including an x position, a y position, a z position, and a rotation for each joint). In some embodiments, other types of virtual skeletons may be used (e.g., a wireframe, a set of shape primitives, etc.).

Skeletal modeling may be performed by the gaming system. In some embodiments, the gaming system may include a dedicated skeletal modeler that can be used by a variety of different applications. In this way, each application does not have to independently interpret depth maps as machine readable skeletons. Instead, the individual applications can receive the virtual skeletons in an anticipated data format from the dedicated skeletal modeler (e.g., via an application programming interface or API). In some embodiments, the dedicated skeletal modeler may be a remote modeler accessible via a network. In some embodiments, an application may itself perform skeletal modeling.

During game output 38, the physical movements of game player 18 as recognized via the virtual skeleton 36 are used to control aspects of a game, application, or operating system. In the illustrated scenario, game player 18 is playing a fantasy themed game and has performed a cart-driving gesture. The game recognizes the gesture by analyzing the virtual skeleton 36, and displays an image of the hands of a player character 16 reining a horse that is pulling a cart. In some embodiments, an application may leverage various graphics hardware and/or graphics software to render an interactive interface (e.g., a cart-driving game) for display on a display device.

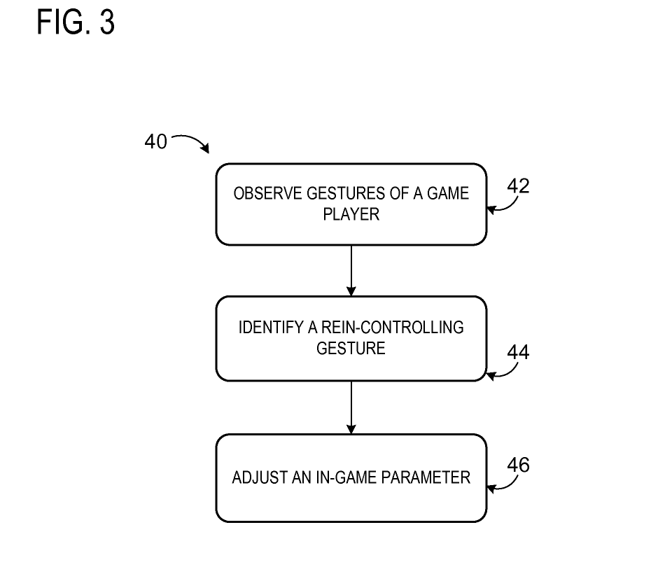

FIG. 3 shows an example method 40 of observing gestures of a game player, identifying the observed gestures, and adjusting an in-game parameter responsive to the observed gestures. Method 40 may be performed by an animal driving or riding game executing on gaming system 12 for example.

At 42, method 40 includes observing gestures of a game player. In some embodiments, the game player may be observed by a depth camera and modeled with a virtual skeleton, as described above. A position of one or more joints of the virtual skeleton may be translated/interpreted as a rein-controlling gesture based on the relative joint positions and joint movement from frame to frame.

At 44, method 40 includes identifying a rein-controlling gesture of the game player as one of a plurality of different possible rein-controlling gestures. Each different rein-controlling gesture may be characterized by a different posture and/or movement of the virtual skeleton. An animal driving or riding game may recognize the various rein-controlling gestures based on the position of one or more skeletal joints relative to one or more other skeletal joints from frame to frame.

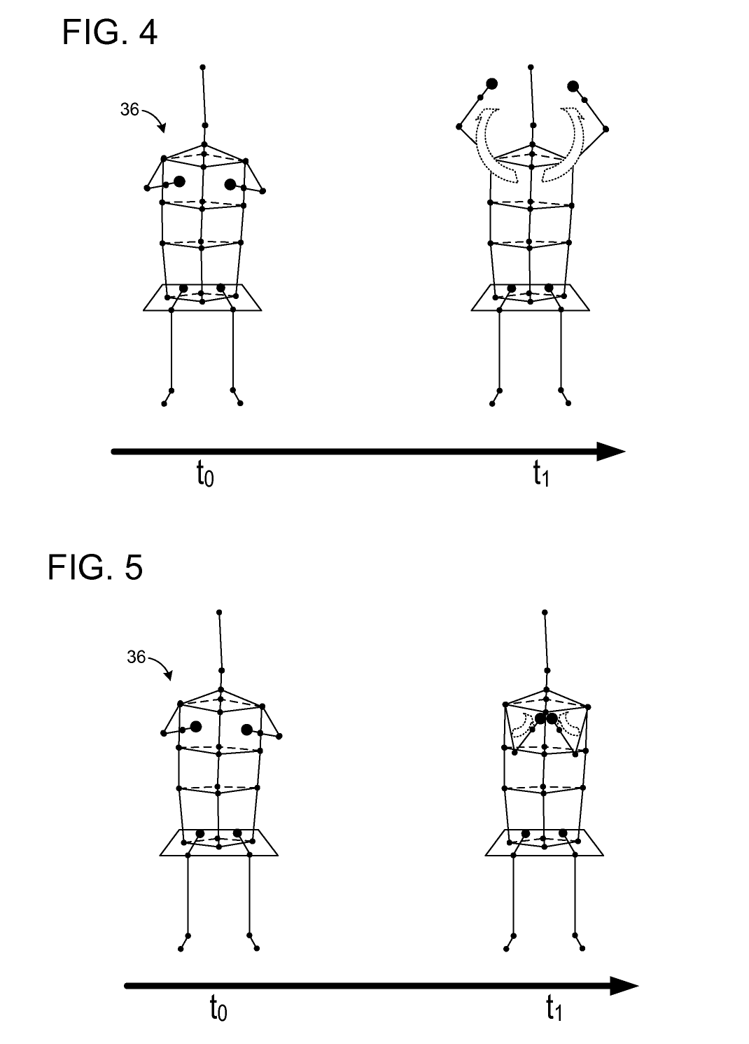

As a non-limiting example, FIG. 4 shows a rein-controlling gesture which may be identified as a hard braking gesture. At time to, virtual skeleton 36 is in a neutral position. For example, the neutral position may be characterized by the hands in front of the torso as if holding reins of a virtual animal within an animal driving or riding game, as described above. As shown, virtual skeleton 36 may move from the neutral position to a position associated with a hard braking gesture at time t₁. In the illustrated embodiment, the hard braking gesture is characterized by a left hand joint and a right hand joint of virtual skeleton 36 moving higher than a shoulder joint of the virtual skeleton. Such a gesture may control one or more aspects of a game, which will be discussed in greater detail below.

As another non-limiting example, FIG. 5 shows a rein-controlling gesture which may be identified as a gentle braking gesture. As shown, virtual skeleton 36 may move from the neutral position at time t₀ to a position associated with a gentle braking gesture at time t₁. In the illustrated embodiment, the gentle braking gesture is characterized by a left hand joint and a right hand joint of virtual skeleton 36 moving toward a torso of the virtual skeleton. Such a gesture may control one or more aspects of a game, which will be discussed in greater detail below.

As another non-limiting example, FIG. 6 shows a rein-controlling gesture which may be identified as a right turn gesture. As shown, virtual skeleton 36 may move from the neutral position at time to to a position associated with a right turn gesture at time t₁. In the illustrated embodiment, the right turn gesture is characterized by a right hand joint of virtual skeleton 36 moving back toward a torso of the virtual skeleton to a greater degree than a left hand joint of the virtual skeleton. Likewise, it will be appreciated that a rein-controlling gesture may be identified as a left turn gesture if a left hand joint of the virtual skeleton moves back toward a torso of the virtual skeleton to a greater degree than a right hand joint of the virtual skeleton, for example. Such gestures may control one or more aspects of a game, which will be discussed in greater detail below.

As another non-limiting example, FIG. 7 shows a rein-controlling gesture which may be identified as a thrashing gesture. As shown, virtual skeleton 36 may move from the neutral position at time to to a position with the left and right hands above the shoulder joints at time t₁, and to a position with the left and right hands below the shoulder joints at time t₂. It will be appreciated that while the illustrated embodiment shows the thrashing gesture at times t₁ and t₂, that the thrashing gesture may be further characterized by a left hand joint and a right hand joint of virtual skeleton 36 repeatedly moving up and down (e.g., by repeating the gestures at times t₁ and t₂).

Returning to FIG. 3, at 46, responsive to the rein-controlling gesture, method 40 includes adjusting an in-game parameter. Non-limiting examples of in-game parameters that may be adjusted include, but are not limited to, the speed of the game animal and/or the vehicle pulled by the game animal; the direction of the game animal and/or the vehicle pulled by the game animal; the jumping of the game animal; and the tenacity, bravado, and/or flamboyancy of the game animal.

For example, the hard braking gesture illustrated in FIG. 4 and the gentle braking gesture illustrated in FIG. 5 may correspond to decreasing the speed of the virtual animal, wherein the speed is reduced responsive to the braking gestures. It will be appreciated that the hard braking gesture and the gentle braking gesture may produce different rates of deceleration. For example, the hard braking gesture may reduce the speed of the virtual animal more quickly than the gentle braking gesture.

As another non-limiting example, the thrashing gesture illustrated in FIG. 7 may correspond to increasing the speed of the virtual animal, wherein the speed is increased responsive to the thrashing gesture.

As another non-limiting example, the in-game parameter may be associated with a direction of the virtual animal. For example, the right turn gesture illustrated in FIG. 6 may correspond to an in-game parameter adjustment, wherein the direction of the virtual animal is turned to the right, responsive to the right turn gesture. Likewise, the direction of the virtual animal may be turned left responsive to a left turn gesture.

Furthermore, in some embodiments, a rein-controlling gesture may be performed with a discernable duration, spatial magnitude, and/or velocity such that the in-game parameter is adjusted proportionally to the gesture. For example, the speed of the virtual animal may be reduced in proportion to the duration of the gentle braking gesture. As such, a short duration of the gentle braking gesture may reduce the speed of the virtual animal, whereas a longer duration of the gentle braking gesture may bring the virtual animal to a stop, for example.

As another example, the direction of the virtual animal may adjust in proportion to a spatial magnitude of a right turn gesture. In other words, a greater space between the right hand joint and the left hand joint of the virtual skeleton may correspond to a sharper turn to the right, and a lesser space between the right hand joint and the left hand joint may correspond to a slighter turn to the right, for example.

As another example, the speed of the virtual animal may be increased in proportion to the velocity of the repeated up and down movements of the thrashing gesture. As such, a high velocity thrashing gesture may adjust the in-game parameter such that the speed of virtual animal changes from a walk to a gallop, whereas a low velocity thrashing gesture may change the speed of the virtual animal from a walk to a trot, for example.

It is to be understood that the outcome of virtually any rein-controlling gesture may by based on the duration, spatial magnitude, and/or velocity of the gesture, and the examples provided above are non-limiting.

Furthermore, it is to be understood that the example joint positions illustrated in the drawings and described above are not meant to be limiting. A gesture may be characterized by virtually any number of absolute and/or relative joint positions, joint velocities, joint accelerations, and/or joint rotations. Recognition of any particular gesture may be based on one or more tests and/or heuristics. Such tests and/or heuristics may be performed by the game, an operating system, and/or a dedicated gesture recognition engine.

Also, it is to be understood that the example rein-controlling gestures provided above are not limiting. This disclosure is equally applicable to other gestures that simulate a character riding an animal (e.g., horse, dragon, dolphin, panther, etc.) and/or controlling one or more animals pulling a vehicle (e.g., chariot, horse cart, dog sled, etc.).

Returning to FIG. 3, it will be appreciated that method 40 is provided by way of example and may include additional or alternative steps than those shown in FIG. 3. For example, method 40 may further include identifying gestures other than rein-controlling gestures and adjusting an in-game parameter in response to the identified gesture.

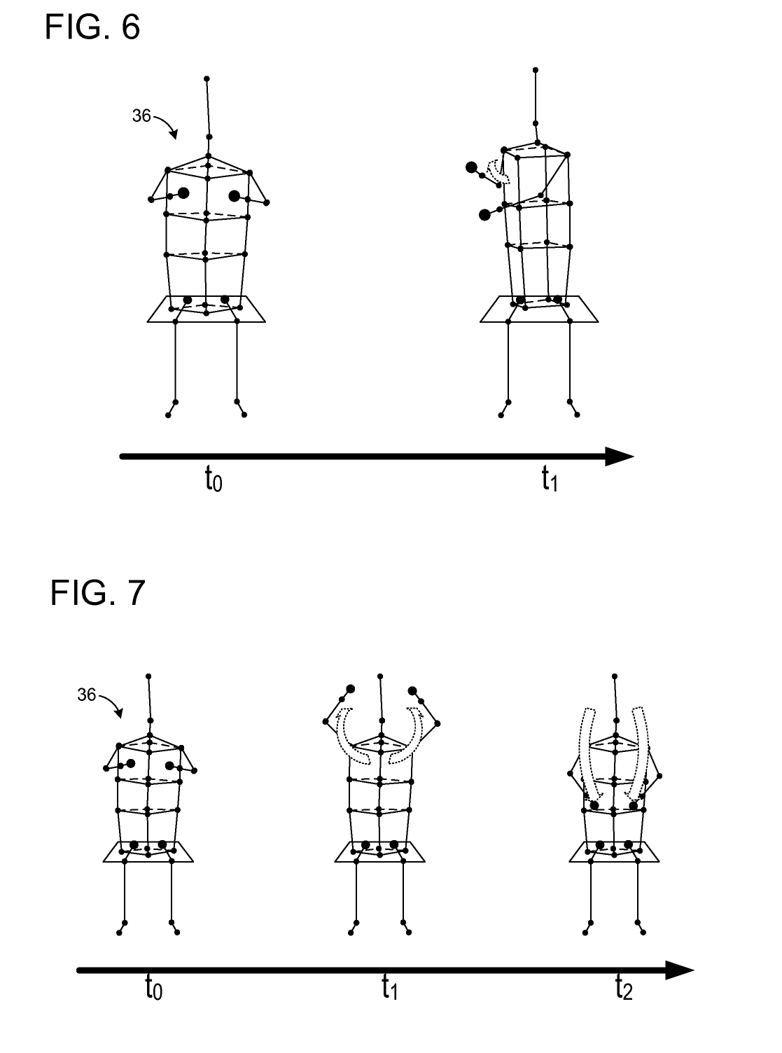

As a non-limiting example, FIG. 8 shows an item-collecting gesture. As shown, virtual skeleton 36 may move from the neutral position at time t₀ to a position with the left and right hands together in front of the torso at time t₁. Such a movement may be interpreted as passing one rein to the other hand such that one hand holds both reins. In this way, the free hand (e.g., the hand that no longer holds the reins) may be available to perform an item-collecting gesture. At time t₂, the left hand is shown in the neutral position, which may be identified as the hand holding both reins, while the right hand is raised above the right shoulder joint. Responsive to the item-collecting gesture, an in-game parameter corresponding to a player character inventory may be adjusted. Continuing with the animal driving or riding game as an example, a game player may perform an item-collecting gesture to acquire a virtual item (e.g., magic crystals that provide the driver/rider with spell casting abilities) while driving or riding the virtual animal.

In some embodiments, one or more aspects of the gesture-based interactive interface controls described above may be replaced or augmented with audio controls. For example, returning to FIG. 2, instead of or in addition to visually observing and modeling a game player, a gaming system may acoustically observe and model a game player. In particular, a microphone may be used to listen to the game player, and the sounds made by the game player may serve as audible commands, which may be identified by the gaming system. Audible commands may take a variety of different forms, including but not limited to spoken words, grunts, claps, stomps, and/or virtually any other sounds that a game player is capable of making.

As a non-limiting example, an audible command may be identified as one of a plurality of different rein-controlling commands, each rein-controlling command associated with a different in-game parameter that may be adjusted by a game player that controls a player character within the animal driving or riding game.

FIG. 2 schematically shows game player 18 shouting the command “giddy up” while an animal driving or riding game is in a driving/riding mode. Such a command may be used to adjust the speed of a virtual animal, for example. Such audible speed selection may be used instead of gestural rein-controlling selection in some embodiments. As schematically illustrated in FIG. 2, the observed sounds of a game player, as input via a microphone, may be analyzed to identify spoken commands. As a non-limiting example, a speech recognition algorithm may be used to model the spoken sounds as machine readable words.

In some embodiments, audible commands may be used to modify an aspect of a rein-control. As a non-limiting example, the magnitude of a rein-control may be increased in proportion to the volume with which an audible command is delivered. As another example, the effectiveness of a rein-control may be modified based on the content, timing, and/or volume with which an audible command is delivered.

While the above described examples are provided in the context of an animal driving or riding game, it is to be understood that the principles discussed herein may be applied to other types of games, applications, and/or operating systems. In particular, a variety of different interactive interfaces may be controlled as described above. The rein-controlling gestures described above may be used to select other actions executable within a particular interactive interface. When outside the realm of animal driving or riding games, such gestures may be referred to as action selection gestures instead of rein-controlling gestures and/or item-collecting gestures.

In some embodiments, the above described methods and processes may be tied to a computing system including one or more computers. In particular, the methods and processes described herein may be implemented as a computer application, computer service, computer API, computer library, and/or other computer program product.

FIG. 9 schematically shows a non-limiting computing system 48 that may perform one or more of the above described methods and processes. Computing system 48 is shown in simplified form. It is to be understood that virtually any computer architecture may be used without departing from the scope of this disclosure. In different embodiments, computing system 48 may take the form of a console gaming device, a hand-held gaming device, a mobile gaming device, a mainframe computer, a server computer, a desktop computer, a laptop computer, a tablet computer, a home entertainment computer, a network computing device, a mobile computing device, a mobile communication device, etc. Gaming system 12 of FIG. 1 is a non-limiting embodiment of computing system 48.

Computing system 48 may include a logic subsystem 50, a data-holding subsystem 52, a display subsystem 54, a capture device 56, and/or a communication subsystem 58. The computing system may optionally include components not shown in FIG. 9, and/or some components shown in FIG. 9 may be peripheral components that are not integrated into the computing system.

Logic subsystem 50 may include one or more physical devices configured to execute one or more instructions. As such, logic subsystem 50 may be operatively connectable to the data-holding subsystem 52. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

For example, as described above, logic subsystem 50 may be configured to execute instructions to render an animal driving or riding game for display on a display device, and receive a virtual skeleton including a plurality of joints. Further, the logic subsystem may be configured to identify a rein-controlling gesture, item-collection gesture, and/or audible rein-control command, and adjust an in-game parameter responsive to the aforementioned gestures and/or commands.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 52 may include one or more physical, non-transitory, devices configured to hold data and/or instructions executable by the logic subsystem to implement the herein described methods and processes. When such methods and processes are implemented, the state of data-holding subsystem 52 may be transformed (e.g., to hold different data and/or instructions). For example, data-holding subsystem 52 may hold instructions executable by the logic subsystem to cause the display device to render a virtual animal and reins extending between the hands of an in-game player character, wherein hands of the in-game player character are controlled by movements of a game player.

Data-holding subsystem 52 may include removable media and/or built-in devices. Data-holding subsystem 52 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 52 may include devices with one or more of the following characteristics: volatile, nonvolatile, dynamic, static, read/write, read-only, random access, sequential access, location addressable, file addressable, and content addressable. In some embodiments, logic subsystem 50 and data-holding subsystem 52 may be integrated into one or more common devices, such as an application specific integrated circuit or a system on a chip.

FIG. 9 also shows an aspect of the data-holding subsystem in the form of removable computer-readable storage media 60, which may be used to store and/or transfer data and/or instructions executable to implement the herein described methods and processes. Removable computer-readable storage media 60 may take the form of CDs, DVDs, HD-DVDs, Blu-Ray Discs, EEPROMs, and/or floppy disks, among others.

It is to be appreciated that data-holding subsystem 52 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

Display subsystem 54 may be used to present a visual representation of data held by data-holding subsystem 52. As the herein described methods and processes change the data held by the data-holding subsystem, and thus transform the state of the data-holding subsystem, the state of display subsystem 54 may likewise be transformed to visually represent changes in the underlying data. Display subsystem 54 may include one or more display devices utilizing virtually any type of technology. Such display devices may be combined with logic subsystem 50 and/or data-holding subsystem 52 in a shared enclosure, or such display devices may be peripheral display devices, as shown in FIG. 1. In some embodiments, the computing system may include a display output (e.g., an HDMI port) to output an interactive interface to a display device.

Computing system 48 further includes a capture device 56 configured to obtain depth images of one or more targets. Capture device 56 may be configured to capture video with depth information via any suitable technique (e.g., time-of-flight, structured light, stereo image, etc.). As such, capture device 56 may include a depth camera (such as depth camera 22 of FIG. 1), a video camera, stereo cameras, and/or other suitable capture devices. In some embodiments, the computing system may include a peripheral input (e.g., a USB 2.0 port) to receive depth images from a capture device.

In one embodiment, capture device 56 may include left and right cameras of a stereoscopic vision system. Time-resolved images from both cameras may be registered to each other and combined to yield depth-resolved video. In other embodiments, capture device 56 may be configured to project onto an observed scene a structured infrared illumination comprising numerous, discrete features (e.g., lines or dots). Capture device 56 may be configured to image the structured illumination reflected from the scene. Based on the spacings between adjacent features in the various regions of the imaged scene, a depth map of the scene may be constructed.

In other embodiments, Capture device 56 may be configured to project a pulsed infrared illumination onto the scene. One or more cameras may be configured to detect the pulsed illumination reflected from the scene. For example, two cameras may include an electronic shutter synchronized to the pulsed illumination, but the integration times for the cameras may differ, such that a pixel-resolved time-of-flight of the pulsed illumination, from the source to the scene and then to the cameras, is discernable from the relative amounts of light received in corresponding pixels of the two cameras.

In some embodiments, two or more different cameras may be incorporated into an integrated capture device. For example, a depth camera and a video camera (e.g., RGB video camera) may be incorporated into a common capture device. In some embodiments, two or more separate capture devices may be cooperatively used. For example, a depth camera and a separate video camera may be used. When a video camera is used, it may be used to provide target tracking data, confirmation data for error correction of target tracking, image capture, face recognition, high-precision tracking of fingers (or other small features), light sensing, and/or other functions.

It is to be understood that at least some depth mapping and/or gesture recognition operations may be executed by a logic machine of one or more capture devices. A capture device may include one or more onboard processing units configured to perform one or more target analysis and/or tracking functions. A capture device may include firmware to facilitate updating such onboard processing logic.

In some embodiments, computing system 48 may include a communication subsystem 58. When included, communication subsystem 58 may be configured to communicatively couple computing system 48 with one or more other computing devices. Communication subsystem 58 may include wired and/or wireless communication devices compatible with one or more different communication protocols. As non-limiting examples, the communication subsystem may be configured for communication via a wireless telephone network, a wireless local area network, a wired local area network, a wireless wide area network, a wired wide area network, etc. In some embodiments, the communication subsystem may allow computing system 48 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A data-holding subsystem holding instructions executable by a logic subsystem to:
render an animal driving or riding game for display on a display device;
receive a virtual skeleton including a plurality of joints, the virtual skeleton providing a machine readable representation of a game player observed with a depth camera;
identify a rein-controlling gesture of the virtual skeleton; and
responsive to the rein-controlling gesture, adjust an in-game parameter of a virtual animal within the animal driving or riding game.

2. The data-holding subsystem of claim 1, wherein the rein-controlling gesture is a hard braking gesture characterized by a left hand joint and a right hand joint of the virtual skeleton moving higher than a shoulder joint of the virtual skeleton.

3. The data-holding subsystem of claim 2, wherein the in-game parameter of the virtual animal is a speed of the virtual animal, and wherein the speed of the virtual animal is reduced responsive to the hard braking gesture.

4. The data-holding subsystem of claim 1, wherein the rein-controlling gesture is a gentle braking gesture characterized by a left hand joint and a right hand joint of the virtual skeleton moving toward a torso of the virtual skeleton.

5. The data-holding subsystem of claim 4, wherein the in-game parameter of the virtual animal is a speed of the virtual animal, and wherein the speed of the virtual animal is reduced responsive to the gentle braking gesture.

6. The data-holding subsystem of claim 1, wherein the rein-controlling gesture is a left turn gesture characterized by a left hand joint of the virtual skeleton moving back toward a torso of the virtual skeleton to a greater degree than a right hand joint of the virtual skeleton.

7. The data-holding subsystem of claim 6, wherein the in-game parameter of the virtual animal is a direction of the virtual animal, and wherein the direction of the virtual animal is turned to the left responsive to the left turn gesture.

8. The data-holding subsystem of claim 1, wherein the rein-controlling gesture is a right turn gesture characterized by a right hand joint of the virtual skeleton moving back toward a torso of the virtual skeleton to a greater degree than a left hand joint of the virtual skeleton.

9. The data-holding subsystem of claim 8, wherein the in-game parameter of the virtual animal is a direction of the virtual animal, and wherein the direction of the virtual animal is turned to the right responsive to the right turn gesture.

10. The data-holding subsystem of claim 1, wherein the rein-controlling gesture is a thrashing gesture characterized by a left hand joint and a right hand joint of the virtual skeleton repeatedly moving up and down.

11. The data-holding subsystem of claim 10, wherein the in-game parameter of the virtual animal is a speed of the virtual animal, and wherein the speed of the virtual animal is increased responsive to the thrashing gesture.

12. The data-holding subsystem of claim 1, wherein the in-game parameter is adjusted in proportion to a duration of the rein-controlling gesture.

13. The data-holding subsystem of claim 1, wherein the in-game parameter is adjusted in proportion to a spatial magnitude of the rein-controlling gesture.

14. The data-holding subsystem of claim 1, wherein the in-game parameter is adjusted in proportion to a velocity of the rein-controlling gesture.

15. The data-holding subsystem of claim 1, further holding instructions executable by a logic subsystem to:
identify an item-collecting gesture of the virtual skeleton; and
responsive to the item-collecting gesture, adjust an in-game parameter of a player character inventory within the animal driving or riding game.

16. The data-holding subsystem of claim 1, further holding instructions executable by the logic subsystem to cause the display device to render the virtual animal; hands of an in-game player character controlled by movements of the game player; and reins extending between the hands of the in-game player character and the virtual animal.

17. A method of executing an animal driving or riding game on a computing system, the method comprising:
observing gestures of a game player with a depth camera;
identifying a rein-controlling gesture of the game player; and
responsive to the rein-controlling gesture, adjusting an in-game parameter of a virtual animal within the animal driving or riding game.

18. The method of claim 17, wherein the in-game parameter is adjusted in proportion to a duration, spatial magnitude, and/or velocity of the rein-controlling gesture.

19. An entertainment system, comprising:
a peripheral input to receive depth images from a depth camera;
a display output to output an interactive interface to a display device;
a logic subsystem operatively connectable to the depth camera via the peripheral input and to the display device via the display output; and
a data-holding subsystem holding instructions executable by the logic subsystem to:
receive from the depth camera one or more depth images of a world space scene including a computer user;
model the computer user with a virtual skeleton including a plurality of joints;
recognize a rein-controlling gesture of the game player; and
responsive to the rein-controlling gesture, adjust an in-game parameter of a virtual animal within the animal driving or riding game.

20. The system of claim 19, wherein the in-game parameter is adjusted in proportion to a duration, spatial magnitude, and/or velocity of the rein-controlling gesture.
